(19) United States
(12) Patent Application Publication
(10) Pub. No.: US 2023/0264875 A1
(43) Pub. Date: Aug. 24, 2023

(54) ENVIRONMENTALLY FRIENDLY PUSH-PULL TYPE NON-CIRCULAR CYLINDRICAL CONTAINER

(71) Applicant: Dongguan JieDaXing Printing Co., Ltd., Guangdong (CN)

(72) Inventor: Fafu ZHU, Guangdong (CN)

(73) Assignee: Dongguan JieDaXing Printing Co., Ltd., Guangdong (CN)

(21) Appl. No.: 17/943,179

(22) Filed: Sep. 12, 2022

(30) Foreign Application Priority Data
Feb. 24, 2022 (CN) 202220400908.1

(51) Int. Cl. B65D 65/38; B65D 83/00

(52) U.S. Cl. CPC B65D 65/38; B65D 83/0011; B65D 2565/381

(57) ABSTRACT

An environmentally friendly push-pull type non-circular cylindrical container includes a paper lid. A bottom side of the paper lid is fixedly installed with an inner tube that is fixedly sheathed with an elliptical tube. An inner wall of the elliptical tube is fixedly installed with a bottom bracket and a fixed gasket. A same rotary toothed piece is movably installed on a side of the bottom bracket and the fixed gasket close to each other. An inner wall of the toothed piece is movably installed with a limiting wood shaft. A threaded rod is movably installed on the limiting wood shaft, and is movably sheathed with a gasket located on a top side of the toothed piece. The threaded rod is sheathed with a nut, a piston piece is fixedly installed on a top side of the nut, and the piston piece contacts an inner wall of the inner tube.

### CROSS-REFERENCE TO RELATED APPLICATION

This application claims the priority benefit of China application serial no. 202220400908.1, filed on Feb. 24, 2022. The entirety of the above-mentioned patent application is hereby incorporated by reference herein and made a part of this specification.

### BACKGROUND

### Technical Field

The present invention relates to the field of environmentally friendly containers, and in particular to an environmentally friendly push-pull type non-circular cylindrical container.

### Description of Related Art

Daily chemical deodorant cream/lipsticks are generally stored in boxes with pushing functions.

In the prior art, in an existing daily chemical deodorant cream/lipstick box or other box that implements a pushing function, a plastic or metal part must be used in the structure. Moreover, it takes a long time for plastic and metal to degrade. If a box with a plastic or metal part is thrown away after use, it may also pollute the environment. In addition, the production cost is also increased in the production process, so an environmentally friendly push-pull type non-circular cylindrical container is required to meet people's needs.

### SUMMARY

The purpose of the present invention is to provide an environmentally friendly push-pull type non-circular cylindrical container, so as to solve the problems that a plastic or metal part must be used in the structure of the box with the pushing function proposed in the background art mentioned above, direct disposal after use may cause environmental pollution, and the production cost may also increase.

To achieve the above-mentioned purpose, the present invention provides the following technical solution. An environmentally friendly push-pull type non-circular cylindrical container includes a paper lid. A bottom side of the paper lid is fixedly installed with an inner tube, the inner tube is fixedly sheathed with an elliptical tube, an inner wall of the elliptical tube is fixedly installed with a bottom bracket and a fixed gasket, a same rotary toothed piece is movably installed on a side of the bottom bracket and the fixed gasket close to each other, an inner wall of the rotary toothed piece is movably installed with a limiting wood shaft, a solid wood threaded rod is movably installed on the limiting wood shaft, the solid wood threaded rod is movably sheathed with a gasket, the gasket is located on a top side of the rotary toothed piece, the solid wood threaded rod is movably sheathed with a solid wood nut, a piston piece is fixedly installed on a top side of the solid wood nut, and the piston piece is in contact with an inner wall of the inner tube.

With an environmentally friendly push-pull type non-circular cylindrical container in this technical solution, a wood/bamboo rod is embedded as the solid wood nut, which simply and effectively realizes a matching function with the solid wood threaded rod. By combining this telescopic assembly with a paper tube and a rotating paper sheet, a product is obtained which perfectly realizes a telescopic function of an inner space of the non-circular container and completely removes plastic and metal components, thus realizing a truly environmentally friendly packaging and further reducing environmental pollution.

Preferably, both sides of the elliptical tube are respectively provided with operation holes, the rotary toothed piece penetrates through the two operation holes, and the rotary toothed piece can be rotated through the operation holes on both sides of the elliptical tube.

Preferably, the solid wood threaded rod is provided with an insertion hole, the limiting wooden shaft is movably installed in the insertion hole, and rotation of the limiting wooden shaft will drive the solid wood threaded rod to rotate by means of the insertion hole in the solid wood threaded rod.

Preferably, the rotary toothed piece is provided with a limiting hole, the limiting wooden shaft is matched with the limiting hole, and rotation of the rotary toothed piece will drive the limiting wood shaft to rotate by means of the limiting hole.

Preferably, the gasket is provided with a movable hole, and the solid wood threaded rod penetrates through the movable hole. When the solid wood threaded rod rotates, the gasket will not be affected by the solid wood threaded rod through the movable hole, thus preventing the gasket from rotating and increasing wear.

Preferably, the piston piece is provided with a linkage hole, and the solid wood threaded rod penetrates through the linkage hole. Sliding of the solid wood nut will drive the piston piece on the top side to slide, and the piston piece will slide along the solid wood threaded rod through the linkage hole.

The beneficial effects of the present invention are as follows.

In the present invention, through arrangement of the rotary toothed piece, the solid wood threaded rod, and the solid wood nut, a wood/bamboo rod is embedded as the solid wood nut, which simply and effectively realizes a matching function with the solid wood threaded rod. By combining this telescopic assembly with a paper tube and a rotating paper sheet, a product is obtained which perfectly realizes a telescopic function of an inner space of the non-circular container and completely removes plastic and metal components, thus realizing a truly environmentally friendly packaging and further reducing environmental pollution.

In the present invention, through arrangement of the elliptical tube, in order to completely remove plastic and metal materials of this kind of box, the elliptical tube and other product materials only contain paper and natural solid wood (bamboo), thereby reducing the production cost to a certain extent.

### BRIEF DESCRIPTION OF THE DRAWINGS

FIG. 1 is a schematic diagram of a three-dimensional structure of an environmentally friendly push-pull type non-circular cylindrical container proposed by the present invention;

FIG. 2 is a schematic structural diagram of an inner tube part of an environmentally friendly push-pull type non-circular cylindrical container proposed by the present invention;

FIG. 3 is a schematic structural diagram of an elliptical tube part of an environmentally friendly push-pull type non-circular cylindrical container proposed by the present invention;

FIG. 4 is a schematic structural diagram of a bottom bracket part of an environmentally friendly push-pull type non-circular cylindrical container proposed by the present invention;

FIG. 5 is a schematic structural diagram of a solid wood nut part of an environmentally friendly push-pull type non-circular cylindrical container proposed by the present invention;

FIG. 6 is a schematic structural diagram of a rotary toothed piece part of an environmentally friendly push-pull type non-circular cylindrical container proposed by the present invention;

FIG. 7 is a schematic structural diagram of a limiting hole part of an environmentally friendly push-pull type non-circular cylindrical container proposed by the present invention;

FIG. 8 is a schematic cross-sectional diagram of a structure of an inner tube and elliptical tube part of an environmentally friendly push-pull type non-circular cylindrical container proposed by the present invention; and

FIG. 9 is a schematic structural diagram of part A in FIG. 8 of an environmentally friendly push-pull type non-circular cylindrical container proposed by the present invention.

### DESCRIPTION OF THE EMBODIMENTS

The technical solution in the embodiments of the present invention will be clearly and completely described below in conjunction with the accompanying drawings of the embodiments of the present invention; and obviously, the embodiments described are merely some, rather than all, of the embodiments of the present invention.

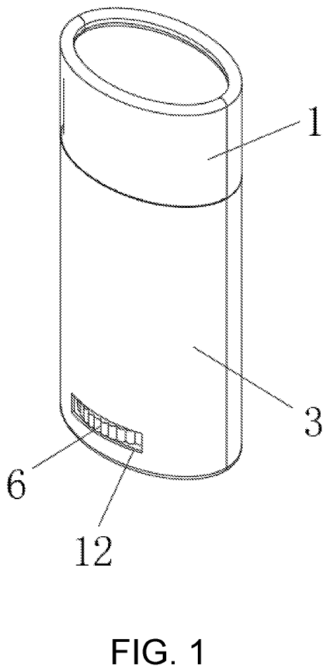

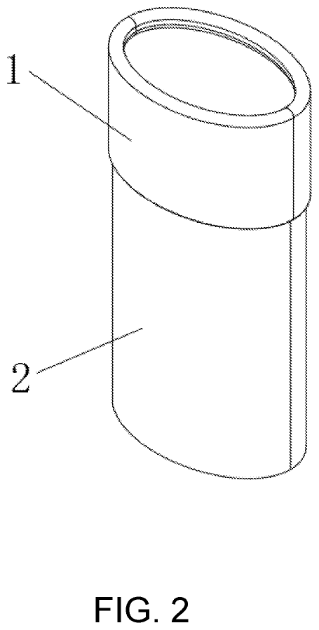

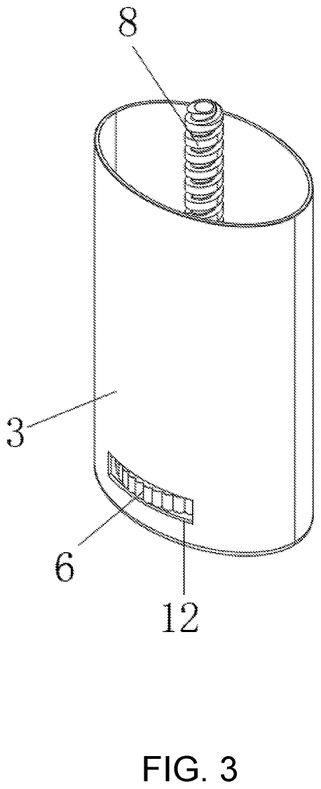

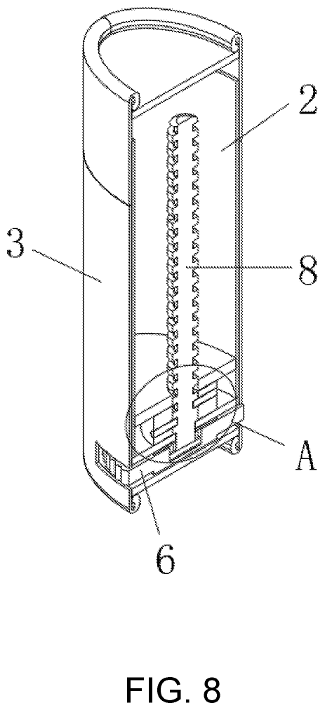

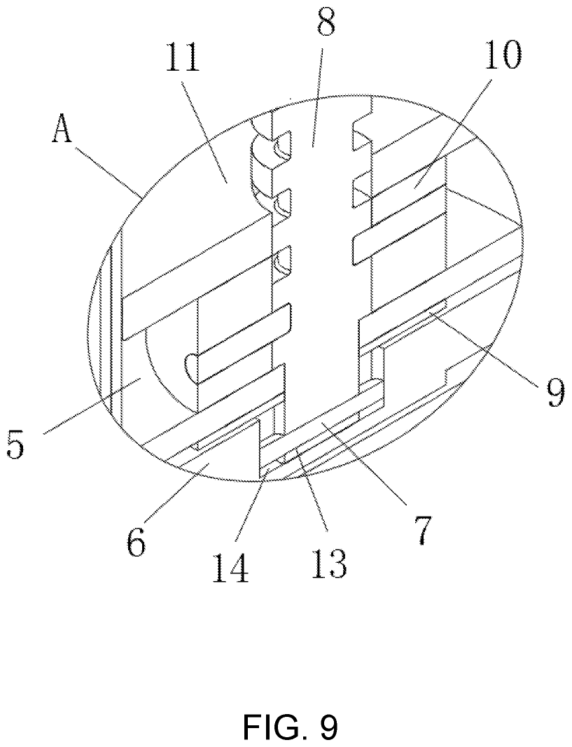

Referring to FIG. 1 to FIG. 9, an environmentally friendly push-pull type non-circular cylindrical container includes a paper lid 1. A bottom side of the paper lid 1 is fixedly installed with an inner tube 2. The inner tube 2 is fixedly sheathed with an elliptical tube 3. An inner wall of the elliptical tube 3 is fixedly installed with a bottom bracket 4 and a fixed gasket 5. A same rotary toothed piece 6 is movably installed on a side of the bottom bracket 4 and the fixed gasket close to each other. An inner wall of the rotary toothed piece 6 is movably installed with a limiting wood shaft 7. A solid wood threaded rod 8 is movably installed on the limiting wood shaft 7. The solid wood threaded rod 8 is movably sheathed with a gasket 9. The gasket 9 is located on a top side of the rotary toothed piece 6. The solid wood threaded rod 8 is movably sheathed with a solid wood nut 10. A piston piece 11 is fixedly installed on a top side of the solid wood nut 10. The piston piece 11 is in contact with an inner wall of the inner tube 2. When in use, the rotary toothed piece 6 is rotated, and the friction of the rotary toothed piece 6 may be reduced by the gasket 9, so that the rotary toothed piece 6 can rotate more smoothly. The rotation of the rotary toothed piece 6 will drive the limiting wooden shaft 7 to rotate, and the rotation of the limiting wooden shaft 7 will drive the solid wood threaded rod 8 to rotate. However, the solid wood nut 10 cannot rotate due to the influence of the piston piece 11, such that when the solid wood threaded rod 8 rotates, it will drive the solid wood nut 10 to slide along the solid wood threaded rod 8. Sliding of the solid wood nut 10 will drive the piston piece 11 on the top side to slide, and moving of the piston piece 11 may drive canned cream to move up and down.

Referring to FIG. 1 to FIG. 3, in the present invention, both sides of the elliptical tube 3 are respectively provided with operation holes 12, the rotary toothed piece 6 penetrates through the two operation holes 12, and the rotary toothed piece 6 can be rotated through the operation holes 12 on both sides of the elliptical tube 3.

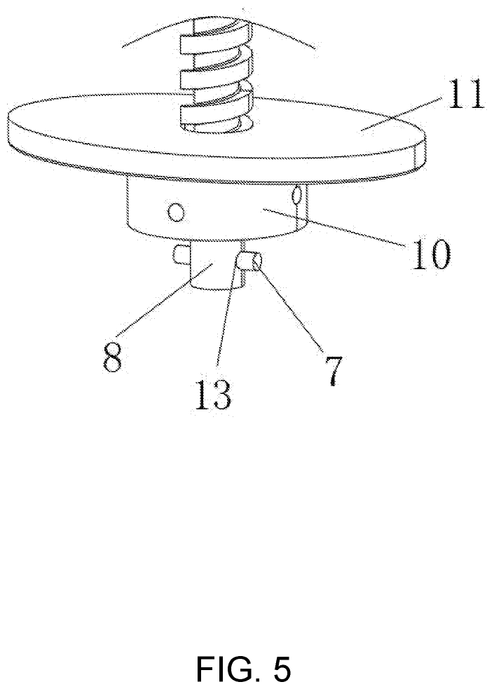

Referring to FIG. 5 to FIG. 9, in the present invention, the solid wood threaded rod 8 is provided with an insertion hole 13, the limiting wooden shaft 7 is movably installed in the insertion hole 13, and rotation of the limiting wooden shaft 7 will drive the solid wood threaded rod 8 to rotate by means of the insertion hole 13 in the solid wood threaded rod 8.

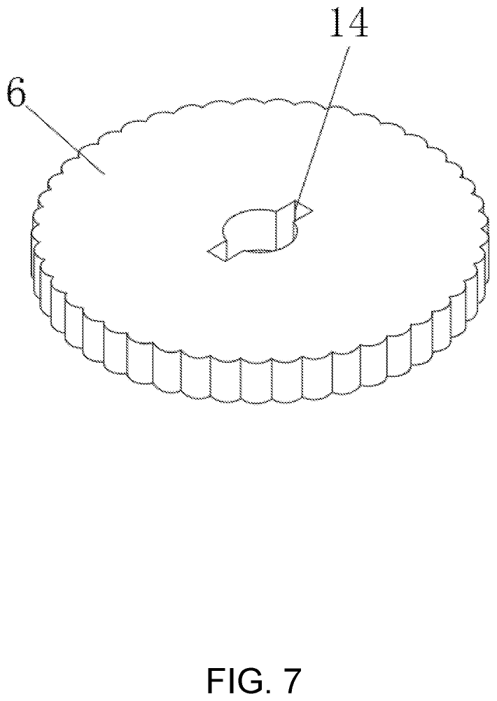

Referring to FIG. 7 to FIG. 9, in the present invention, the rotary toothed piece 6 is provided with a limiting hole 14, the limiting wooden shaft 7 is matched with the limiting hole 14, and rotation of the rotary toothed piece 6 will drive the limiting wood shaft 7 to rotate by means of the limiting hole 14.

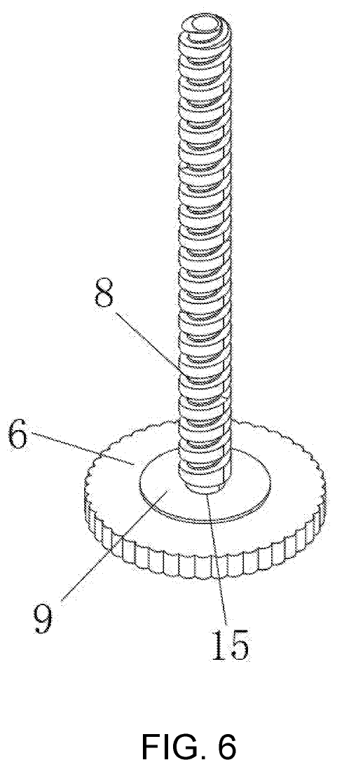

Referring to FIG. 6, in the present invention, the gasket 9 is provided with a movable hole 15, and the solid wood threaded rod 8 penetrates through the movable hole 15. When the solid wood threaded rod 8 rotates, the gasket 9 will not be affected by the solid wood threaded rod 8 through the movable hole 15, thus preventing the gasket 9 from rotating and increasing wear.

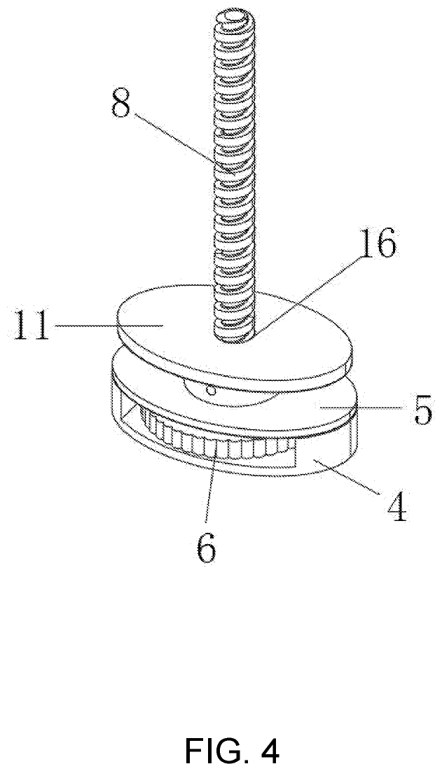

Referring to FIG. 4, in the present invention, the piston piece 11 is provided with a linkage hole 16, and the solid wood threaded rod 8 penetrates through the linkage hole 16. Sliding of the solid wood nut 10 will drive the piston piece 11 on the top side to slide, and the piston piece 11 will slide along the solid wood threaded rod 8 through the linkage hole 16.

The working principle of the present invention is as follows.

A push-pull function can be realized by using the solid wood nut 10 and the solid wood threaded rod 8. The solid wood nut 10 is bonded with the piston piece 11 and then they are tightly attached to the inner wall of the tube to form a “piston-like” device. The solid wood threaded rod 8 is rotated to push and pull the “piston-like” device formed by the solid wood nut bonded with the piston piece 11 and then tightly attached to the inner wall of the tube, thus realizing the moving up and down of the canned cream. The bottom of the solid wood threaded rod 8 is designed to be combined with the rotary toothed piece 6 (its diameter is larger than the short diameter of the elliptical outer tube, and its edge is splined to facilitate toggle rotation) in mortise and tenon, which enhances the torque and is easy to assemble. Holes (with widths smaller than the diameter of the rotary toothed piece 6 and heights greater than the thickness of the rotary toothed piece 6 combined with the solid wood threaded rod 8) are opened in the long-diameter plane of the elliptical tube 3 of the outer box. Gaskets 9 with diameters smaller than that of the rotary toothed piece 6 are respectively placed between the rotary toothed piece 6, the bottom of the outer box and the bottom of the inner box, so as to reduce the friction when the rotary toothed piece 6 rotates. In order to completely remove plastic and metal materials of this kind of box, the product materials only contain paper and natural solid wood (bamboo), which realizes a truly environmentally friendly packaging.

When in use, the rotary toothed piece 6 can be rotated through the operation holes 12 on both sides of the elliptical tube 3, and the friction of the rotary toothed piece 6 can be reduced through the gasket 9, so that the rotary toothed piece 6 can rotate more smoothly. The rotation of the rotary toothed piece 6 will drive the limiting wood shaft 7 to rotate through the limiting hole 14, and the rotation of the limiting wood shaft 7 will drive the solid wood threaded rod 8 to rotate through the insertion hole 13 in the solid wood threaded rod 8. The solid wood nut 10 cannot rotate due to the influence of the piston piece 11, such that when the solid wood threaded rod 8 rotates, it will drive the solid wood nut 10 to slide along the solid wood threaded rod 8. Sliding of the solid wood nut 10 will drive the piston piece 11 on the top side to slide, and the piston piece 11 will slide along the solid wood threaded rod 8 through the linkage hole 16, such that the piston piece 11 does not deflect when it slides and the moving of the piston piece 11 may drive the canned cream to move up and down.

The above descriptions are merely the preferred specific embodiments of the present invention, but the protection scope of the present invention is not limited thereto, and any equivalent replacements or modifications made by skilled persons who are familiar with the technical field in the art, within the technical scope disclosed by the present invention and according to the technical solution of the present invention and its inventive concept, shall fall within the protection scope of the present invention.

What is claimed is:

1. An environmentally friendly push-pull type non-circular cylindrical container, comprising a paper lid, wherein a bottom side of the paper lid is fixedly installed with an inner tube, the inner tube is fixedly sheathed with an elliptical tube, an inner wall of the elliptical tube is fixedly installed with a bottom bracket and a fixed gasket, a same rotary toothed piece is movably installed on a side of the bottom bracket and the fixed gasket adjacent to each other, an inner wall of the rotary toothed piece is movably installed with a limiting wood shaft, a solid wood threaded rod is movably installed on the limiting wood shaft, the solid wood threaded rod is movably sheathed with a gasket, the gasket is located on a top side of the rotary toothed piece, the solid wood threaded rod is movably sheathed with a solid wood nut, a piston piece is fixedly installed on a top side of the solid wood nut, and the piston piece is in contact with an inner wall of the inner tube.

2. The environmentally friendly push-pull type non-circular cylindrical container of claim 1, wherein both sides of the elliptical tube are respectively provided with operation holes, and the rotary toothed piece penetrates through the two operation holes.

3. The environmentally friendly push-pull type non-circular cylindrical container of claim 1, wherein the solid wood threaded rod is provided with an insertion hole, and the limiting wooden shaft is movably installed in the insertion hole.

4. The environmentally friendly push-pull type non-circular cylindrical container of claim 1, wherein the rotary toothed piece is provided with a limiting hole, and the limiting wooden shaft is matched with the limiting hole.

5. The environmentally friendly push-pull type non-circular cylindrical container of claim 1, wherein the gasket is provided with a movable hole, and the solid wood threaded rod penetrates through the movable hole.

6. The environmentally friendly push-pull type non-circular cylindrical container of claim 1, wherein the piston piece is provided with a linkage hole, and the solid wood threaded rod penetrates through the linkage hole.
